(19) United States
(12) Patent Application Publication
(10) Pub. No.: US 2024/0281489 A1
(43) Pub. Date: Aug. 22, 2024

(54) SYSTEM, METHOD, AND APPLICATION FOR EMBEDDED INTERNET SEARCHING AND RESULT DISPLAY FOR PERSONALIZED LANGUAGE AND VOCABULARY LEARNING

(71) Applicant: Aum Mehta, Furlong, PA (US)

(72) Inventor: Aum Mehta, Furlong, PA (US)

(21) Appl. No.: 18/646,079

(22) Filed: Apr. 25, 2024

Related U.S. Application Data
(60) Provisional application No. 63/498,707, filed on Apr. 27, 2023.

(51) Int. Cl. G06F 16/9538; G06F 40/232; G06F 40/242; G06F 40/295; G06F 40/30; G06V 30/10

(52) U.S. Cl. CPC G06F 16/9538; G06F 40/232; G06F 40/242; G06F 40/295; G06F 40/30; G06V 30/10

(57) ABSTRACT

A personalized language and vocabulary learning system, method, and application is disclosed. A computer-implemented system for language and vocabulary learning is described. The system includes a software tool, browser extension, or mobile application that generates a customized list of words based on content being read, listened, or watched. The tool identifies unfamiliar words, fetches comprehensive vocabulary data, and allows users to review, and revise collected words. It filters out common words, utilizes advanced natural language processing algorithms, and offers customization options. Users can add words to their vocabulary lists, generate flashcards or quizzes, and view familiarity levels with a highlighting module. The tool is compatible with various browsers and operating systems, can be integrated into existing applications, and offers options for reminders, audio or video presentations. It serves as a valuable resource for easily accessing and learning from a comprehensive vocabulary database, aiding in language learning and vocabulary expansion.

### TECHNICAL FIELD

Embodiments of the present invention are in the field of web browsers, search engines, and language and vocabulary learning. More particularly to system, method and application for embedded internet searching and result display for personalized language and vocabulary learning.

### BACKGROUND

Internet searching using general search engines is a well-known process. Examples of common search engines include Google, Yahoo, AltaVista, AskJeeves, MSNSearch, HotBot, AOL Search, etc. There are also many specialized search engines that focus on particular subject matters, such as technology, sports, shopping or travel. The manner in which such search engines work is well known to those skilled in the art.

Typically, at the user level, internet searching is performed by manually entering the search terms into the search engine, either by typing the search terms or by cutting and pasting the search text into a search box on the search engine portal. The search engine then performs the search of the internet web pages and returns the results in a list form on the search engine page. These results are typically displayed in the user's web browser software. This internet search process typically requires that the search engine portal be open in a web browser and operated directly by the user. Generally, if a user wishes to conduct multiple searches on multiple search engines, each search query must be separately entered and repeated on each of the selected search engine portals. Moreover, saving the separate search results from each separate search performed on each separate search engine generally requires cutting and pasting of displayed results into a file, or otherwise saving off-line each of the search engine's resultant webpage(s), etc.

Conventional Internet search engines and toolbar-based search engines are used for only the first part of the search process, e.g., the query submission. The second part of the process involves the display and selection or search results, which are typically loaded into the web browser and presented to the user via a separate web page rather than the search engine interface. Such existing search engines generally do not have any capabilities for displaying a search result, either collapsed or opened/expanded, through anything other than a web page.

Therefore, with a conventional Internet search engine, when a user enters a search term and hits ‘Enter’, the page/site that the user is viewing via the browser is entirely replaced with a search result page generated by the search engine. Thus, the user of a conventional search engine is unable to view the current page of interest while performing searches. Moreover, the user is unable to simultaneously view the search and search results once the user has selected a search result and directed the browser to a particular search result page. This could be problematic if the user desires to view the content of the current page while performing searches on other related or unrelated subjects of interest, or continue to view and/or refine a search after selecting and browsing to a particular search result page.

Recently, commercial search engine portals, such as WebCrawler, Yahoo and Google, have developed “toolbars” that may be installed as a plug in for web browsers. These toolbars enable users to enter the search terms in the search box in the toolbar, instead of having to go to the actual search engine portal directly. Typically, when a search is conducted using a toolbar, the user enters the search text into the search box of the toolbar and commands a search to be performed, at which time the browser is redirected to the search portal and the results displayed in the browser or in a separate window generated by the browser.

Now turning towards some specific problem that the conventional techniques/approaches have not taken into consideration to enrich the user experience while browsing/surfing. Normally people read a lot of contents (form example, books and articles) from various web sites. There are times when the user may not know a word or meaning thereof and may end up making a wild guess (for example based on the meaning of a sentence or context based). But many times, when the user read contents, such as but not limited to, speeches or English from the past to science magazines, the user come across words where the user may not have any clue on what that word means. In such cases, the user goes to search engines and look for the meaning and then the user use sites which allow to create flash cards. The user takes one word at once, then learns and adds to a list or flash cards. This process is tedious and many times if there are too many words, the user may lose interest in learning or reading the article.

### SUMMARY OF THE INVENTION

Embodiments of the present invention are in the field of web browsers, search engines, and language and vocabulary learning. More particularly to system, method and application for embedded internet searching and result display for personalized language and vocabulary learning.

This invention relates to personalized language and vocabulary learning system, method and application. The computer-implemented system for language and vocabulary learning is described in this invention. The computer-implemented system includes a software tool, browser extension, or mobile application that generates a customized list of words based on content being read, listened to, or watched. The tool identifies unfamiliar words, fetches comprehensive vocabulary data, and allows users to review, and revise collected words. It filters out common words, utilizes advanced natural language processing algorithms, and offers customization options. Users can add words to their vocabulary lists, generate flashcards or quizzes, and view familiarity levels with a highlighting module. The tool is compatible with various browsers and operating systems, can be integrated into existing applications, and offers options for reminders, audio or video presentations. It serves as a valuable resource for easily accessing and learning from a comprehensive vocabulary database, aiding in language learning and vocabulary expansion. The abstract provides a concise overview of the invention's features and benefits in facilitating language learning through a computer-implemented system.

Aspects of the present invention discloses system, method and application that enables to create list of words beforehand and present it to the user so that the user can review words first and then read the article.

Further, the system, method and application of the present invention enables to allows user to look for the words, definitions, synonyms and antonyms right there on that browser or PC or app where you read the article or listen to the audio or watch video.

The summary of the invention does not necessarily disclose all the features essential for defining the invention. The invention may reside in a sub-combination of the disclosed features. The various combination and sub-combination are fully described in the detailed description.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates an exemplary screenshot of working of the present invention that allows user to look for the words, definitions, synonyms and antonyms right there on that browser or PC or app where you read the article or listen to the audio or watch video (a user interface), in accordance with an embodiment of the present invention.

FIG. 2 illustrates an exemplary system for enhancing vocabulary comprehension, in accordance with an embodiment of the present invention.

FIG. 3 illustrates various elements, components, units/portions, and/or modules in the exemplary electronic device and/or the exemplary server, in accordance with an embodiment of the present invention.

FIG. 4 illustrates a flowchart of a method for enhancing vocabulary comprehension, in accordance with an embodiment of the present invention.

FIGS. 5A-5D illustrates exemplary working of the invention, in accordance with an embodiment of the present invention.

### DETAILED DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure.

In the following description, numerous specific details are set forth in order to provide a thorough understanding of embodiments of the present invention. It will be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

The present invention provides the capability to easily conduct various internet searches using words or phrases from an existing document as query terms, and then return the results for use in the same document. It is contemplated that, when installed, the present invention will include any of a new toolbar, tool bar buttons, information pop up or drop down menus, an extension etc., that will be accessible from the window toolbar or sidebar areas, or by right or left mouse clicks where appropriate, (e.g., on selected words or phrases, menu items invoking sub-menus, etc.). The invention is particularly applicable when robust searches are required, or when the computing device or electronic device has cumbersome or limited keyboard or input device (such as a pda, cell phone, tablet pc, etc.).

Disclosed herein are computer-assistance algorithms used to assist human readers in the task of image interpretation, which can incorporate one or more of artificial intelligence (AI), deep learning (DL), machine learning (ML), computer-aided techniques, and other algorithms. Disclosed herein are systems, software, and methods for presenting the AI output to a clinician and to aid in producing a report. In some aspects, the system is also used to generate analytics for the purposes of business management, quality assurance, and self-improvement.

Keyword extraction (to create list of words beforehand and present it to the user so that he can review words first and then read the article) is the identification, within a supplied document, of one or more keywords which can be used to locate information of interest within the document. An example of a list or collection of keywords that can be used for finding useful information is a back-of-the-book index for a book-length document. Such back-of-the-book indexes are generated manually by human indexing professionals. Automation of this task would save a great deal of labor and facilitate possible information lookup on documents that would otherwise never have had indexes. There are also many uses for keyword extraction on shorter documents, such as online web pages, abstracts, or articles. However, most documents are not supplied with a collection of related keywords generated either by the human author, another human, or automatically. Therefore, it would be desirable to have a means for processing any document automatically using a computer to generate the keywords. A related task that requires keyword extraction is that of annotating a document with links to sources of additional information. It is very important that keywords that are generated be useful and relevant to human readers as well as to automatic systems that might process the document or collections of documents that are so indexed. The standard for quality of collections of keywords remains indexes and keyword collections that are generated by humans. The present invention provides a method of automatically processing electronic documents containing text, in order to extract useful collections of keywords, which achieves a goal of more closely approaching a quality of output like that generated by human authors and/or professional indexers.

The present invention applies recent advances in artificial intelligence, specifically machine learning techniques, together with novel features that provide machine learning or ranking algorithms with high-quality and numeric quantitative information as to the relevance of extracted candidate keywords. The inventive methods of deriving and applying these new features to generate collections of keywords is shown to result in improved performance over state-of-the-art keyword extraction algorithms, and to enable further novel applications in annotating text with links to relevant reference information.

In an exemplary embodiment, two types of machine learning algorithms are referred to as supervised learning and unsupervised learning. In supervised learning, an algorithm generates a function that maps inputs to desired outputs, often formulated as a “classification” problem, in which the training data is provided with several input-output examples demonstrating a desired mapping. In unsupervised learning, an algorithm functions as an agent which models a set of inputs, but labeled examples are not available to train the algorithm in making classification decisions. Both types of algorithms use the concept of a “feature.” Features are individual measurable heuristic properties of the phenomena being observed that can be used to create a numerical representation of the phenomena, which are in this case word patterns. Removing irrelevant and redundant features from the input data improves processing speed and efficiency by reducing the dimensionality of the problem. Feature selection, that is, choosing discriminating and independent features, is key to any pattern recognition algorithm, and also helps researchers to better understand the data, which features are important, and how they are related to one another.

In one embodiment of the present invention, a supervised learning approach (supervised method) uses a set of (mostly numerical) features (an n-dimensional “feature vector”) that are chosen for their effectiveness in separating desired and undesired entries, and examples of documents together with collections of keywords that have been generated by humans (manually-constructed) are provided as training data to a machine learning algorithm. In another embodiment, an unsupervised method can use similar features selected for their sensitivity to parameters of relevance in ranking keywords, but in the absence of training data, it might use numeric values derived from the feature vectors to perform scoring and ranking of candidate entries. Subsequently, a number of candidate entries to be retained in a keyword collection can be selected using predetermined criteria for quality or for a desired number of entries. Thus, the present invention provides both unsupervised and supervised embodiments of an automatic keyword extraction method.

Examples of algorithms and corresponding classifiers used in supervised and unsupervised methods include Naïve Bayes, Support Vector Machine (SVM), Relevance Vector Machine (RVM), decision tree, genetic algorithm, rule induction, k-Nearest Neighbors, Gaussian, Gaussian Mixture Model, artificial neural networks, multilayer perceptron, and radial basis function (RBF) networks.

The invention is best understood by explanation of its operation from within a familiar framework, such as composing a document that exists in Microsoft Word. However, as will by understood by those skilled in the art, the invention is applicable to any of the various document composing or reviewing programs such as Microsoft Word, Open Office Write, Adobe Acrobat, Outlook, Wordperfect, Eudura, Outlook Express, etc., in any of the various configuration of such software, (e.g., desktop version, mobile version, table PC version, etc.) and regardless of the underlying code used to develop such software, (e.g., C, C++, Visual BASIC, JAVA, etc.).

In an embodiment, the present invention relates to computer-implemented system for language and vocabulary learning described in this invention includes a software tool, browser extension, or mobile app that generates a customized list of words based on content being read, listened to, or watched. The tool identifies unfamiliar words, fetches comprehensive vocabulary data, and allows users to review, and revise collected words. It filters out common words, utilizes advanced natural language processing algorithms, and offers customization options. Users can add words to their vocabulary lists, generate flashcards or quizzes, and view familiarity levels with a highlighting module. The tool is compatible with various browsers and operating systems, can be integrated into existing applications, and offers options for reminders, audio or video presentations. It serves as a valuable resource for easily accessing and learning from a comprehensive vocabulary database, aiding in language learning and vocabulary expansion. The abstract provides a concise overview of the invention's features and benefits in facilitating language learning through a computer-implemented system.

In an exemplary embodiment, the present invention creates a list of words beforehand and present it to the user so that he can review words first and then read the article.

In an exemplary embodiment, the present invention allows user to look for the words, definitions, synonyms and antonyms right there on that browser or PC or app where you read the article or listen to the audio or watch video.

In an exemplary embodiment, the present invention a computer-implemented system for facilitating language and vocabulary learning. The computer-implemented system includes software tool, browser extension, or mobile app, hereinafter referred to as “the tool”, configured to run on a computing device and/or on an electronic device, including but not limited to a computer, smartphone, mobile phone, PDA, or tablet.

In an exemplary embodiment, the computer-implemented system of the present invention includes a tool designed to automatically generate a customized list of words based on the content being read, listened to, or watched on the device.

In an exemplary embodiment, the computer-implemented system of the present invention includes a tool that identifies specific words that the user may or may not know, based on an intelligent algorithm that analyzes the text, audio content, audio from video or subtitles from the video.

In an exemplary embodiment, the computer-implemented system of the present invention includes a tool that automatically fetches comprehensive vocabulary data, including definitions, antonyms, synonyms, examples, usage tips and other relevant information, for the selected words from single or multiple sources.

In an exemplary embodiment, the computer-implemented system of the present invention includes a tool that provides users an option to invoke the vocabulary-module by selecting the word while reading, listening, or watching and present all details about the word.

In an exemplary embodiment, the computer-implemented system of the present invention includes a tool that provides different options to select the words incase if the vocabulary module is invoked manually.

In an exemplary embodiment, the computer-implemented system of the present invention includes a tool that provides a vocabulary presentation module configured to present a list of all the collected words along with their definitions to the user, thereby enabling the user to review the vocabulary words before reading the article.

In an exemplary embodiment, the computer-implemented system of the present invention includes a tool that provides additional contextual information along with definitions, such as synonyms, antonyms, usage examples, or related images, to enhance the user's understanding of the vocabulary words.

In an exemplary embodiment, the computer-implemented system of the present invention includes a tool that filters out common words, such as articles, prepositions, and conjunctions, from the generated word list to focus on unfamiliar vocabulary.

In an exemplary embodiment, the computer-implemented system of the present invention includes a tool that utilizes advanced natural language processing algorithms to accurately identify and extract relevant vocabulary data, ensuring high accuracy and reliability.

In an exemplary embodiment, the computer-implemented system of the present invention includes a tool that provides a way to add selected or extracted words or text data to their vocabulary lists with or without user input, further comprising the step of automatically generating flashcards or quizzes from the extracted words or text data to facilitate vocabulary learning.

In an exemplary embodiment, the computer-implemented system of the present invention includes a tool that provides a highlighting module configured to highlight the collected words in different colors based on their familiarity level to indicate to the user which words they may already know and which words they may not know.

In an exemplary embodiment, the computer-implemented system of the present invention includes a tool that provides a customization module configured to customize the highlighting colors based on user preferences, such as color-blindness or personal color preferences.

In an exemplary embodiment, the computer-implemented system of the present invention includes a tool that updates the user's vocabulary profile based on the user's interactions with the presented unknown words using the simple or AI based algorithm.\

In an exemplary embodiment, the computer-implemented system of the present invention includes a tool that provides an interaction monitoring module configured to monitor the user's interaction with the highlighted words to determine if the user interacts with the highlighted words by hovering, clicking, or indicating familiarity in any other way.

In an exemplary embodiment, the computer-implemented system of the present invention includes a tool that provides familiarity updating module configured to update the familiarity level of the words based on the user's interaction with the highlighted words.

In an exemplary embodiment, the computer-implemented system of the present invention includes a tool that provides an option to the user to review and revise stored lists.

In an exemplary embodiment, the computer-implemented system of the present invention includes a tool that provides the option of automatically generating flash cards based on the collected words and presenting the flash cards to the user for review and reminders through mobile apps or other means.

In an exemplary embodiment, the computer-implemented system of the present invention includes a tool that is compatible with various browsers and operating systems, making it accessible to a wide range of users.

In an exemplary embodiment, the computer-implemented system of the present invention includes a tool that can be customized to suit the user's preferences, such as the choice of data sources, display settings, language options and how to select words manually.

In an exemplary embodiment, the computer-implemented system of the present invention includes a tool that can be seamlessly integrated into existing applications or used as a standalone application, providing flexibility and convenience to users.

In an exemplary embodiment, the computer-implemented system of the present invention includes a tool that can be set up to remind users and share words from their vocabulary lists.

In an exemplary embodiment, the computer-implemented system of the present invention includes a tool that provides the option to present the words through audio or video files to accommodate different learning preferences of users.

In an exemplary embodiment, the computer-implemented system of the present invention includes a tool that provides a valuable resource for users to easily access and learn from a vast and comprehensive vocabulary database, saving time and effort in searching for word definitions and other related information.

In an exemplary embodiment, the computer-implemented system of the present invention includes a tool that facilitates user interaction through speech and voice commands.

In an exemplary embodiment, the computer-implemented system of the present invention includes a tool that is designed to facilitate language learning by helping users identify and focus on specific words they may not know, thereby aiding in the expansion of their vocabulary.

In an exemplary embodiment, the computer-implemented system of the present invention includes a tool that is not limited to any specific language.

In an exemplary embodiment, the computer-implemented system of the present invention includes a tool that will have the ability to interact with the user in Chat style, present data through text, audio, or video.

In an exemplary implementation, the computer-implemented system provides highlighted words like in green and orange are possibly the one user may or may not know. Green ones can be the one they have in their existing lists.

In an exemplary implementation, the computer-implemented system provides an automat list of all words, their definition, and when clicked expand and show more details on the right panel.

In an exemplary implementation, the computer-implemented system enables the user to delete, sort words and add them individually to the lists.

In an exemplary implementation, the computer-implemented system enables to change the level by moving the level bar left and right irrespective of user level.

In an exemplary implementation, the computer-implemented system enables the user to upload all words in one go through the button.

The present invention enables to scan the pages automatically.

The present invention enables to only scan pages for the pre-entered website e.g. cnn.com may be the best to capture words, but not required if the user is on the banking site.

The present invention enables to provide that flexibility what websites to scan and not scan to the user through settings and can be voice activated in the future.

The present invention enables a flexibility as to select words, like double click, single click, or wait for 3 seconds with the mouse on the word.

The present invention enables to create flash cards or lists automatically as one option.

The present invention enables to show option in list (3) that will let user see if he has already entered the word in the lists or flash cards. This way there will be no redundant data.

In an exemplary implementation, a computer-implemented method is provided that includes a step of detecting an event of opening a content on a web browser by a processor of an electronic device such that the detected content is a content currently being accessed by a user; automatically identifying one or more terms present in the detected content, wherein the one or more terms are fetched from a list of pre-determined terms by the user; and automatically identifying, by the processor, one or more terms present in the detected content, wherein the one or more terms are fetched from a list of pre-determined terms by the user.

In an exemplary implementation, the list of pre-determined terms is generated by creating, based on a user selection, a list of terms along with a meaning associated respectively with each of the terms, wherein the meaning of each of the terms is fetched from an internet or manually provided.

In an exemplary implementation, each term in list of terms along with a meaning associated respectively with each of the terms is stored is a separate flashcard.

In an exemplary embodiment, the list of pre-determined terms is generated by automatically adding, upon user selection action, at least one term from the content while the user is accessing the content to a database.

In an exemplary embodiment, the content is a web page.

In an exemplary embodiment, the one or more identified terms are presented to the user: automatically or upon a trigger by the user.

In an exemplary embodiment, at least one term from the one or more identified terms is presented to the user automatically or upon a trigger by the user.

In an exemplary embodiment, the one or more terms present on the detected content is detected based on a complexity threshold selected by the user, the complexity threshold is selected based on the language proficiency level of the user.

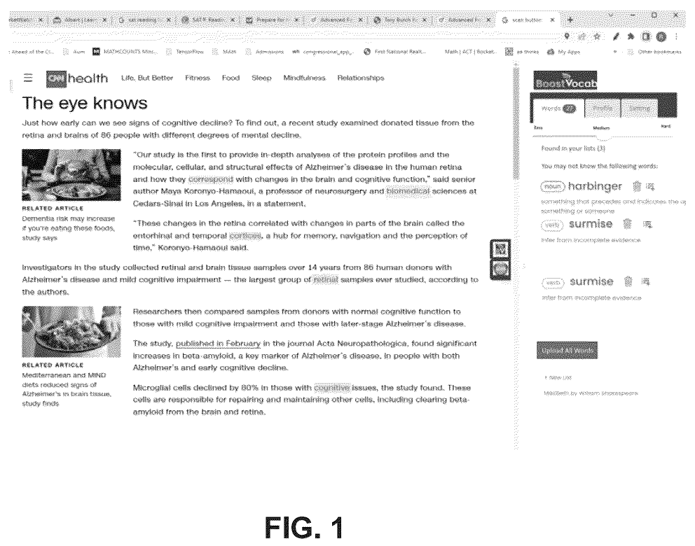

FIG. 1 illustrates an exemplary screenshot of working of the present invention that allows user to look for the words, definitions, synonyms and antonyms right there on that browser or PC or app where you read the article or listen to the audio or watch video (a user interface), in accordance with an embodiment of the present invention.

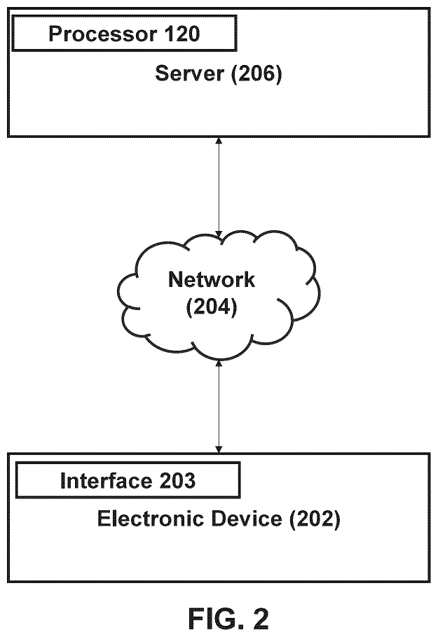

FIG. 2 illustrates an exemplary system for enhancing vocabulary comprehension, in accordance with an embodiment of the present invention. In an embodiment the system includes a user interface 203 of an electronic device 202 configured to display at least one electronic content being selected by a user or received from one or more data sources, and a server 206 communicably coupled to the electronic device 202. The server is coupled to the device via. a network 204.

In this embodiment, the server includes a processor 120. The processor is configured to retrieve at least one electronic content being displayed on the user interface, extract one or more terms from the at least one electronic content, identify at least one unfamiliar word within the one or more extracted terms, retrieve a comprehensive vocabulary data for the at least one identified unfamiliar word, transmit the at least one identified unfamiliar word and the retrieved comprehensive vocabulary data to the electronic device for displaying, on the user interface, to the user.

In an exemplary embodiment, the electronic content and the one or more data sources is selected from any or a combination of text documents, web pages, e-books, e-pdfs and digital articles.

In an exemplary embodiment, the processor is configured to convert, before extracting the one or more terms, the at least one electronic content into a scannable content using a document scanning or a digitization technique, and wherein the document scanning or the digitization technique is selected from any or a combination of an optical character recognition (OCR), image scanning, document imaging, image preprocessing, manual data entry, barcode and QR Code scanning, and automatic document recognition (ADR).

In an implementation of this exemplary embodiment, OCR, which can be used in the present invention, is a common technique used to convert scanned images of text into editable and searchable text. It works by analyzing the shapes of characters in the scanned image and recognizing them as alphanumeric characters. OCR software can extract text from scanned documents and convert it into machine-readable format.

In an implementation of this exemplary embodiment, image scanning, which can be used in the present invention, involves using a scanner device to create a digital image of a physical document. The scanner captures the document as an image file (such as TIFF or JPEG) by illuminating it and recording the reflected light. The resulting image can then be processed further using OCR or other techniques to extract text.

In an implementation of this exemplary embodiment, document imaging systems, which can be used in the present invention, captures digital images of documents using specialized hardware and software. These systems often incorporate features like automatic document feeders, duplex scanning (scanning both sides of a document), and image enhancement algorithms to improve the quality of scanned images.

In an implementation of this exemplary embodiment, image preprocessing, which can be used in the present invention, before OCR, scanned images may undergo preprocessing techniques such as de-skewing (straightening skewed images), despeckling (removing noise or artifacts), and binarization (converting grayscale images to binary black-and-white images). These preprocessing steps help improve the accuracy of OCR by enhancing the quality of the scanned images.

In an implementation of this exemplary embodiment, manual data entry, which can be used in the present invention, where OCR is not suitable due to poor image quality or complex layouts, manual data entry may be employed. Human operators manually transcribe the content of scanned documents into digital format, which can be time-consuming but ensures accuracy.

In an implementation of this exemplary embodiment, for documents containing barcodes or QR codes, specialized scanners can be used to capture and interpret the encoded information. This technique is often used for document tracking, inventory management, and information retrieval purposes.

In an implementation of this exemplary embodiment, an automatic document recognition (ADR) system, which can be used in the present invention, automatically identify and classify different types of documents based on their visual characteristics. Once identified, the documents can be scanned and processed accordingly, with OCR applied to extract text and metadata.

In an exemplary embodiment, after extracting the one or more terms the processor is configured to generate a list of words based on the one or more extracted terms, associate a frequency score to each of the words in the list of words, discard at least one first word from the list of words if the frequency score associated with the at least one first word is greater than or equal to a predefined threshold frequency score, identify at least one second word from the list of words if the frequency score associated with the at least one second word is less than the predefined threshold frequency score, the at least one second word is the at least one unfamiliar word.

In an exemplary embodiment, the processor is configured to automatically retrieve the comprehensive vocabulary data by using or from any or a combination of lexical databases, API Integration, web scraping, local dictionaries, NLP Libraries, word embeddings, crowdsourcing, and a pre-defined vocabulary database.

In an implementation of this exemplary embodiment, as per the present invention, lexical databases like accessing lexical databases such as WordNet, Wiktionary, or the Oxford English Dictionary (OED) can be used that allows for comprehensive retrieval of vocabulary data. These databases contain structured information about words, including their meanings, parts of speech, semantic relationships, and usage.

In an implementation of this exemplary embodiment, as per the present invention, API Integrations can be used. Many online dictionaries and language resources provide Application Programming Interfaces (APIs) that allow developers to programmatically retrieve vocabulary data for words. By integrating with these APIs, applications can access dictionary entries, pronunciation guides, example sentences, and other lexical information.

In an implementation of this exemplary embodiment, as per the present invention, web scraping can be used. Web scraping techniques can be used to extract vocabulary data from online dictionaries, language learning websites, or other sources of lexical information available on the internet. This approach involves parsing HTML or other markup languages to extract relevant data from web pages.

In an implementation of this exemplary embodiment, as per the present invention, local dictionaries can be used. Utilizing local dictionaries or word lists stored in a structured format (such as JSON or XML) allows for offline retrieval of vocabulary data. These dictionaries can be created from publicly available lexical resources or customized to include specific terms and definitions relevant to the application domain.

In an implementation of this exemplary embodiment, as per the present invention, NLP Libraries can be used. The Natural Language Processing (NLP) libraries such as NLTK (Natural Language Toolkit), spaCy, or TextBlob may offer built-in functionality for retrieving vocabulary data. These libraries may include pre-trained models or modules for accessing lexical databases, performing word sense disambiguation, or extracting semantic information from text.

In an implementation of this exemplary embodiment, as per the present invention, word embeddings can be used. The word embeddings generated by techniques like Word2Vec, GloVe, or fastText capture semantic relationships between words in a high-dimensional vector space. Retrieving vocabulary data for a word from word embeddings involves querying the embeddings model to find similar words, synonyms, or related terms based on vector similarity.

In an implementation of this exemplary embodiment, as per the present invention, crowdsourcing can be used. The crowdsourcing platforms like Mechanical Turk or CrowdFlower can be used to collect vocabulary data from human annotators. By presenting users with tasks such as defining a word, providing example sentences, or identifying synonyms, applications can gather vocabulary data from diverse sources.

In an exemplary embodiment, the processor is configured to identify the at least one unfamiliar word within the one or more extracted terms by filtering out common words from the one or more extracted terms. The common words are filtered using a technique selected from any or a combination of stopword removal, predefined lists, frequency analysis, part-of-speech tagging, term frequency-inverse document frequency (TF-IDF), word embeddings, and user-defined lists.

In an implementation of this exemplary embodiment, stopword removal technique can be used. The stopwords are common words in a language that often do not carry significant meaning and can be safely ignored in many text analysis tasks. Examples of stopwords in English include “the,” “and,” “of,” “to,” etc. Stopword removal involves creating a list of stopwords and filtering them out from the content before further analysis.

In an implementation of this exemplary embodiment, predefined lists can be used. The predefined lists of common English stopwords are available in various libraries and resources for natural language processing. These lists can be used directly or customized based on the specific requirements of the text processing task.

In an implementation of this exemplary embodiment, frequency analysis technique can be used. The common words tend to occur frequently in a given text corpus. By analyzing the frequency distribution of words in the content, it is possible to identify and filter out words that appear too frequently to be considered informative or relevant.

In an implementation of this exemplary embodiment, part-of-speech tagging can be used. The part-of-speech tagging assigns grammatical categories (such as nouns, verbs, adjectives, etc.) to words in a text. Common words often belong to certain parts of speech (e.g., articles, conjunctions, pronouns). By tagging words and filtering out those belonging to common parts of speech, it is possible to remove many common words.

In an implementation of this exemplary embodiment, the Term Frequency-Inverse Document Frequency (TF-IDF) technique can be used. The TF-IDF is a statistical measure used to evaluate the importance of a word in a document relative to a collection of documents. Words with high TF-IDF scores are considered more informative and less common. Filtering out words with low TF-IDF scores can help remove common words.

In an implementation of this exemplary embodiment, the word embeddings technique can be use. Word embeddings capture semantic relationships between words in a high-dimensional vector space. Common words often have embeddings that are closer together in the vector space. By clustering embeddings or measuring similarity, it is possible to identify and filter out common words.

In an implementation of this exemplary embodiment, the user-defined lists can be used. In some cases, it may be beneficial to allow users to define their lists of common words based on the specific domain or context of the content. Users can provide lists of words to be filtered out, tailored to their needs.

In an exemplary embodiment, the processor is configured to identify the at least one unfamiliar word within the one or more extracted terms by utilizing a technique selected from any or a combination of Tokenization, stemming and lemmatization, part-of-speech tagging, named entity recognition (NER), word frequency analysis, contextual word embeddings, spell checking and correction, and statistical language models.

In an implementation of this exemplary embodiment, a tokenization technique can be used. The tokenization is the process of breaking down text into individual words or tokens. Simple tokenization algorithms split text based on whitespace or punctuation. By tokenizing the electronic content, it becomes possible to analyze each word separately and identify unfamiliar words.

In an implementation of this exemplary embodiment, a stemming and lemmatization techniques can be used. The stemming and lemmatization are techniques used to reduce words to their root or base form. Stemming algorithms remove prefixes and suffixes from words to extract their stems, while lemmatization algorithms map words to their canonical or dictionary form. Identifying unfamiliar words becomes easier when words are normalized to their base forms.

In an implementation of this exemplary embodiment, a Part-of-Speech Tagging techniques can be used. The Part-of-speech (POS) tagging assigns grammatical categories (e.g., noun, verb, and adjective) to words in a sentence. POS tagging algorithms analyze the context of words and assign appropriate tags based on their syntactic role. Identifying unfamiliar words can involve analyzing their POS tags and comparing them to known vocabulary.

In an implementation of this exemplary embodiment, a named entity recognition (NER) technique can be used. The NER algorithms identify and classify named entities such as persons, organizations, locations, dates, and numerical expressions in text. Unfamiliar words that are identified as named entities may require special handling or further investigation.

In an implementation of this exemplary embodiment, a word frequency analysis technique can be used. The word frequency analysis involves counting the occurrences of words in a text corpus. Words that occur infrequently or are absent from a predefined vocabulary list may be considered unfamiliar. Analyzing word frequencies can help identify rare or specialized terminology.

In an implementation of this exemplary embodiment, a contextual word embeddings technique can be used. The contextual word embeddings such as Word2Vec, GloVe, or BERT capture the semantic meaning of words based on their context in a sentence or document. By comparing the embeddings of words in the electronic content to embeddings of known vocabulary, it is possible to identify words that are semantically dissimilar and potentially unfamiliar.

In an implementation of this exemplary embodiment, a spell checking and correction technique can be use. The spell checking algorithms compare words in the electronic content to a dictionary of correctly spelled words. Words that do not match any entries in the dictionary may be flagged as potentially misspelled or unfamiliar. Spell correction algorithms can suggest alternative spellings or corrections for such words.

In an implementation of this exemplary embodiment, a statistical language models can be used. The statistical language models use probabilistic methods to predict the likelihood of word sequences in a language. Unfamiliar words may have low probabilities of occurring in the context of the surrounding words. By analyzing word sequences and their probabilities, it is possible to identify unfamiliar words.

In an exemplary embodiment, the processor is configured to: identify the at least one unfamiliar word within the one or more extracted terms by statistical analysis or machine learning algorithms to determine the unfamiliarity of words based on user-specific or general language proficiency data.

In an implementation of this embodiment, a build a language proficiency model can be used. The model can work by collecting language proficiency data from users or utilize existing language proficiency datasets, determining features that may indicate language proficiency, such as word frequency, word length, part-of-speech, context, syntactic complexity, etc., and train a statistical model or machine learning classifier using the language proficiency data and extracted features. Commonly used classifiers include logistic regression, decision trees, random forests, or neural networks.

In an implementation of this embodiment feature extraction technique can be used. The frame extraction technique works by extracting features from the extracted terms that may indicate unfamiliarity. These features may include: frequency: Words that occur infrequently in the language proficiency data may be considered unfamiliar; context: analyze the context in which the word appears in the electronic content. Words that occur in unusual or specialized contexts may be unfamiliar, syntactic complexity: words with complex syntactic structures or unusual grammatical patterns may indicate unfamiliarity.

In an implementation of this embodiment word embedding techniques can be used. This technique calculates word embeddings for the extracted terms and compare them to embeddings of known vocabulary. Words with embeddings dissimilar to known vocabulary may be unfamiliar.

In an implementation of this embodiment a training and evaluation models can be used. The models operate by splitting the language proficiency dataset into training and evaluation sets, training the statistical model or machine learning classifier using the training data and extracted features, and evaluating the performance of the model using the evaluation set, using metrics such as accuracy, precision, recall, or F1-score.

In an implementation of this embodiment identifying unfamiliar words technique can be used. The technique applies the trained model to the extracted terms from the electronic content, use the model's predictions to identify unfamiliar words within the extracted terms. Words classified as unfamiliar by the model can be flagged or highlighted for further review or processing.

In an exemplary embodiment, the processor is configured to allow the user to manually review, revise, and annotate the identified unfamiliar words and corresponding vocabulary data.

In an exemplary embodiment, the processor is configured to utilize deep learning, neural networks, or techniques to analyze a semantic context of the electronic content and identify unfamiliar words.

In an exemplary embodiment, the processor is configured to allow user to set language preferences, proficiency levels, word difficulty thresholds, and display preferences.

In an implementation, the network 204 may be configured using a 3G network, a 4G (e.g., LTE) network, a 5G (e.g., NR) network, and a beyond-5G network. Although the electronic device 202 may communicate with the server 206 through network 204, the electronic device 202 may perform direct communication (e.g., sidelink communication) with the server 206 without passing through the network.

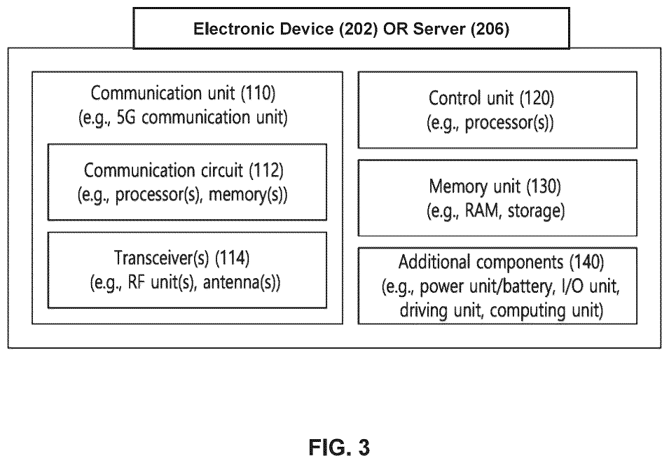

FIG. 3 illustrates various elements, components, units/portions, and/or modules in the exemplary electronic device and/or the exemplary server, in accordance with an embodiment of the present invention.

Referring to FIG. 3, the electronic device 202 or the server 206 may correspond to a device that may be a wireless device or a wired device 2 and may be configured by various elements, components, units/portions, and/or modules. For example, the electronic device 202 or the server 206 may include a communication unit 110, a control unit 120, a memory unit 130, and additional components 140. The communication unit 110 may include a communication circuit 112 and transceiver(s) 114. For example, the communication circuit 112 may include the one or more processors 120 and/or the one or more memories. For example, the transceiver(s) 114 may include the one or more transceivers and/or the one or more antennas 108. The control unit 120 is electrically connected to the communication unit 110, the memory 130, and the additional components 140 and controls overall operation of the electronic device 202 or the server 206. For example, the control unit 120 may control an electric/mechanical operation of the electronic device 202 or the server 206 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the electronic device 202 or the server 206. For example, the additional components 140 may include at least one of a power unit/battery, input/output (I/O) unit (e.g., audio I/O port, video I/O port), a driving unit, and a computing unit.

In FIG. 3, the entirety of the various elements, components, units/portions, and/or modules in the electronic device 202 or the server 206 may be connected to each other through a wired interface or at least a part thereof may be wirelessly connected through the communication unit 110. For example, in each of the electronic device 202 or the server 206, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

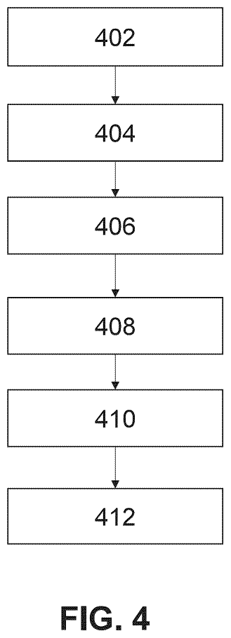

FIG. 4 illustrates a flowchart of a method for enhancing vocabulary comprehension, in accordance with an embodiment of the present invention. As shown in FIG. 4, at step 402, at least one electronic content is displayed on a user interface of an electronic device. The at least one electronic content being selected by a user or received from one or more data sources.

At step 404, a processor of a server communicably coupled to the electronic device retrieves at least one electronic content being displayed on the user interface.

At step 406, the processor extracts one or more terms from the at least one electronic content.

At step 408, the processor identifies at least one unfamiliar word within the one or more extracted terms.

At step 410, the processor retrieves a comprehensive vocabulary data for the at least one identified unfamiliar word.

At step 412, the processor transmits the at least one identified unfamiliar word and the retrieved comprehensive vocabulary data to the electronic device for displaying, on the user interface, to the user.

It needs to be noted that all the embodiment as its implementation details as discussed for the system embodiment of FIG. 2 are equally applicable for method embodiments, however, are not repeated here for the brevity of this document.

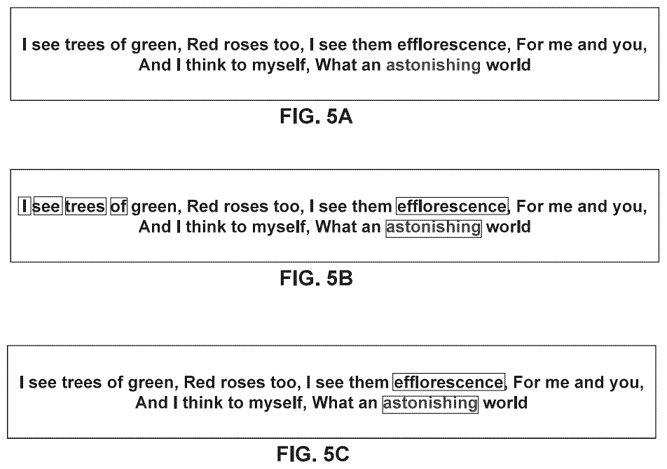

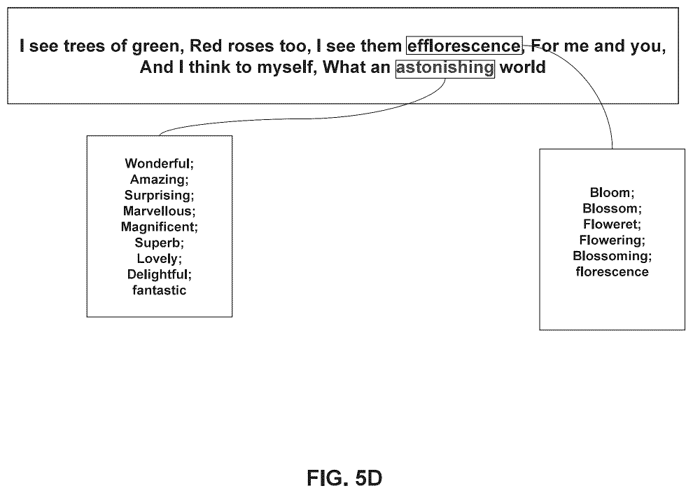

FIGS. 5A-5D illustrates exemplary working of the invention, in accordance with an embodiment of the present invention. As shown in FIG. 5A, a user is reading a digital content “I see trees of green, Red roses too, I see them efflorescence, for me and you, And I think to myself, What an astonishing world”. FIG. 5B shows that as per the present invention the terms are extracted from the contents being read by the user. In this case, the terms/words “I”, “See”, “trees”, “of”, “efflorescence” and “astonishing” are extracted. FIG. 5C shows that out of the extracted words the words efflorescence” and “astonishing” are only the unfamiliar words. Accordingly, as shown in FIG. 5D, the comprehensive vocabulary data for these extracted words are shown to the user voluntarily. The comprehensive vocabulary data may be the easier meaning of the word or synonyms of the words.

In another exemplary embodiment, an electronic device for enhancing vocabulary comprehension is disclosed. The electronic device can include a user interface of an electronic device configured to display at least one electronic content being selected by a user or received from one or more data sources; and a processor configured to: extract one or more terms from the at least one electronic content; identify at least one unfamiliar word within the one or more extracted terms; retrieve a comprehensive vocabulary data for the at least one identified unfamiliar word; transmit the at least one identified unfamiliar word and the retrieved comprehensive vocabulary data to display, on the user interface, to the user.

It needs to be noted that all the embodiment as its implementation details as discussed for the system embodiment of FIG. 2 are equally applicable for method embodiments, however, are not repeated here for the brevity of this document.

While the subject invention is described and illustrated with respect to certain preferred and alternative embodiments, it should be understood that various modifications can be made to those embodiments without departing from the subject invention, the scope of which is defined in the following claims.

What is claimed is:

1. A system for enhancing vocabulary comprehension, the system comprising:
a user interface of an electronic device configured to display at least one electronic content being selected by a user or received from one or more data sources;
a server communicably coupled to the electronic device, the server comprising:
a processor configured to:
retrieve at least one electronic content being displayed on the user interface;
extract one or more terms from the at least one electronic content;
identify at least one unfamiliar word within the one or more extracted terms;
retrieve a comprehensive vocabulary data for the at least one identified unfamiliar word;
transmit the at least one identified unfamiliar word and the retrieved comprehensive vocabulary data to the electronic device for displaying, on the user interface, to the user.

2. The system of claim 1, wherein the electronic content and the one or more data sources is selected from any or a combination of text documents, web pages, e-books, e-pdfs and digital articles.

3. The system of claim 1, wherein the processor is configured to convert, before extracting the one or more terms, the at least one electronic content into a scannable content using a document scanning or a digitization technique, and wherein the document scanning or the digitization technique is selected from any or a combination of an optical character recognition (OCR), image scanning, document imaging, image preprocessing, manual data entry, barcode and QR Code scanning, and automatic document recognition (ADR).

4. The system of claim 1, wherein the processor is configured to:
generate, after extracting the one or more terms, a list of words based on the one or more extracted terms;
associate a frequency score to each of the words in the list of words;
discard at least one first word from the list of words if the frequency score associated with the at least one first word is greater than or equal to a predefined threshold frequency score;
identify at least one second word from the list of words if the frequency score associated with the at least one second word is less than the predefined threshold frequency score, the at least one second word is the at least one unfamiliar word.

5. The system of claim 1, wherein the processor is configured to automatically retrieve the comprehensive vocabulary data by using or from any or a combination of lexical databases, API Integration, web scraping, local dictionaries, NLP Libraries, word embeddings, crowdsourcing, and a pre-defined vocabulary database.

6. The system of claim 1, wherein the processor is configured to:
identify the at least one unfamiliar word within the one or more extracted terms by filtering out common words from the one or more extracted terms, and wherein the common words are filtered using a technique selected from any or a combination of stopword removal, predefined lists, frequency analysis, part-of-speech tagging, term frequency-inverse document frequency (TF-IDF), word embeddings, and user-defined lists; or
identify the at least one unfamiliar word within the one or more extracted terms by utilizing a technique selected from any or a combination of Tokenization, stemming and lemmatization, part-of-speech tagging, named entity recognition (NER), word frequency analysis, contextual word embeddings, spell checking and correction, and statistical language models; or
identify the at least one unfamiliar word within the one or more extracted terms by statistical analysis or machine learning algorithms to determine the unfamiliarity of words based on user-specific or general language proficiency data.

7. The system of claim 1, wherein the processor is configured to:
allow the user to manually review, revise, and annotate the identified unfamiliar words and corresponding vocabulary data;
utilize deep learning, neural networks, or techniques to analyze a semantic context of the electronic content and identify unfamiliar words;
allow user to set language preferences, proficiency levels, word difficulty thresholds, and display preferences.

8. A method for enhancing vocabulary comprehension, the method comprising:
displaying, on a user interface of an electronic device, at least one electronic content being selected by a user or received from one or more data sources;
retrieving, by a processor of a server communicably coupled to the electronic device, at least one electronic content being displayed on the user interface;
extracting, by the processor, one or more terms from the at least one electronic content;
identifying, by the processor, at least one unfamiliar word within the one or more extracted terms;
retrieving, by the processor, a comprehensive vocabulary data for the at least one identified unfamiliar word;
transmitting, by the processor, the at least one identified unfamiliar word and the retrieved comprehensive vocabulary data to the electronic device for displaying, on the user interface, to the user.

9. The method of claim 8, wherein the electronic content and the one or more data sources is selected from any or a combination of text documents, web pages, e-books, e-pdfs and digital articles.

10. The method of claim 8, wherein the method comprising: converting, before extracting the one or more terms, the at least one electronic content into a scannable content using a document scanning or a digitization technique, and wherein the document scanning or the digitization technique is selected from any or a combination of an optical character recognition (OCR), image scanning, document imaging, image preprocessing, manual data entry, barcode and QR Code scanning, and automatic document recognition (ADR).

11. The method of claim 8, wherein the method further comprising:
generating, after extracting the one or more terms, a list of words based on the one or more extracted terms;
associating a frequency score to each of the words in the list of words;
discarding at least one first word from the list of words if the frequency score associating with the at least one first word is greater than or equal to a predefined threshold frequency score;
identifying at least one second word from the list of words if the frequency score associated with the at least one second word is less than the predefined threshold frequency score, the at least one second word is the at least one unfamiliar word.

12. The method of claim 8, wherein the method comprising: retrieving automatically the comprehensive vocabulary data by using or from any or a combination of lexical databases, API Integration, web scraping, local dictionaries, NLP Libraries, word embeddings, crowdsourcing, and a pre-defined vocabulary database.

13. The method of claim 8, wherein the method comprising:
identifying the at least one unfamiliar word within the one or more extracted terms by filtering out common words from the one or more extracted terms, and wherein the common words are filtered using a technique selected from any or a combination of stopword removal, predefined lists, frequency analysis, part-of-speech tagging, term frequency-inverse document frequency (TF-IDF), word embeddings, and user-defined lists; or
identifying the at least one unfamiliar word within the one or more extracted terms by utilizing a technique selected from any or a combination of Tokenization, stemming and lemmatization, part-of-speech tagging, named entity recognition (NER), word frequency analysis, contextual word embeddings, spell checking and correction, and statistical language models; or
identifying the at least one unfamiliar word within the one or more extracted terms by statistical analysis or machine learning algorithms to determine the unfamiliarity of words based on user-specific or general language proficiency data.

14. The method of claim 8, wherein the method comprising:
allowing the user to manually review, revise, and annotate the identified unfamiliar words and corresponding vocabulary data;
utilizing deep learning, neural networks, or techniques to analyze a semantic context of the electronic content and identify unfamiliar words;
allowing user to set language preferences, proficiency levels, word difficulty thresholds, and display preferences.

15. An electronic device for enhancing vocabulary comprehension, the system comprising:
a user interface of an electronic device configured to display at least one electronic content being selected by a user or received from one or more data sources;
a processor configured to:
extract one or more terms from the at least one electronic content;
identify at least one unfamiliar word within the one or more extracted terms;
retrieve a comprehensive vocabulary data for the at least one identified unfamiliar word;
transmit the at least one identified unfamiliar word and the retrieved comprehensive vocabulary data to display, on the user interface, to the user.
